(19) United States
(12) Patent Application Publication
(10) Pub. No.: US 2026/0169325 A1
(43) Pub. Date: Jun. 18, 2026

(54) DISPLAY SUBSTRATE AND MANUFACTURING METHOD

(71) Applicants: Beijing BOE Technology Development Co., Ltd., Beijing (CN); BOE TECHNOLOGY GROUP CO., LTD., Beijing (CN)

(72) Inventors: Yong Yu, Beijing (CN); Chuanxiang Xu, Beijing (CN); Shi Shu, Beijing (CN); Feifei Li, Beijing (CN); Shaohui Li, Beijing (CN); Xiang Li, Beijing (CN); Yang Yue, Beijing (CN); Xinhua Liu, Beijing (CN); Jiahui Han, Beijing (CN); Pengxia Liang, Beijing (CN); Shaopeng Yang, Beijing (CN)

(73) Assignees: Beijing BOE Technology Development Co., Ltd., Beijing (CN); BOE TECHNOLOGY GROUP CO., LTD., Beijing (CN)

(21) Appl. No.: 18/843,061

(22) PCT Filed: Sep. 22, 2023
(86) PCT No.: PCT/CN2023/120766

§ 371 Date: Aug. 30, 2024

(51) Int. Cl. G02F 1/1335; G02F 1/1333

(52) U.S. Cl. CPC G02F 1/133512; G02F 1/133357; G02F 1/133516

(57) ABSTRACT

The present disclosure provides a display substrate and a manufacturing method thereof. The display substrate includes: a base substrate; a plurality of first light shielding members arranged on the base substrate and extending in a first direction; a plurality of light filtering units and a plurality of second light shielding members arranged at a side of the first light shielding member away from the base substrate, the plurality of light filtering units being arranged at intervals, the second light shielding member being filled in a gap between adjacent light filtering units, the second light shielding member extending in a second direction intersecting the first direction; a planarization layer arranged at a side of the plurality of light filtering units and the plurality of second light shielding members away from the base substrate; and a spacer arranged at a side of the planarization layer away from the base substrate.

### TECHNICAL FIELD

The present disclosure relates to the field of display technology, in particular to a display substrate and a manufacturing method thereof.

### BACKGROUND

In a liquid crystal display product, a backlight source is spaced apart from a light-exiting side by a certain distance, so such a phenomenon as crosstalk occurs. Along with an increase in Pixels Per Inch (PPI) of the liquid crystal display product, a pixel size becomes smaller and the crosstalk becomes riskier, so it is necessary to increase a width of a black matrix to reduce the risk of crosstalk. However, at this time, an aperture ratio of the liquid crystal display product decreases.

### SUMMARY

An object of the present disclosure is to provide a display substrate and a manufacturing method thereof, so as to prevent the occurrence of crosstalk, thereby to improve the aperture ratio of the display substrate.

In order to solve the above technical problem, the present disclosure provides the following technical solutions.

In one aspect, the present disclosure provides in some embodiments a display substrate, including: a base substrate; a plurality of first light shielding members arranged on the base substrate and extending in a first direction; a plurality of light filtering units and a plurality of second light shielding members arranged at a side of the first light shielding member away from the base substrate, the plurality of light filtering units being arranged at intervals, the second light shielding member being filled in a gap between adjacent light filtering units, the second light shielding member extending in a second direction, and the first direction intersecting the second direction; a planarization layer arranged at a side of the plurality of light filtering units and the plurality of second light shielding members away from the base substrate; and a spacer arranged at a side of the planarization layer away from the base substrate.

In a possible embodiment of the present disclosure, surfaces of the plurality of light filtering units and the plurality of second light shielding members at a side away from the base substrate have roughness of less than or equal to 0.5 μm.

In a possible embodiment of the present disclosure, a height difference between the light filtering unit and the adjacent second light shielding member in a direction perpendicular to the base substrate and away from the base substrate is less than 0.5 μm.

In a possible embodiment of the present disclosure, a thickness of the planarization layer is less than 1 μm.

In a possible embodiment of the present disclosure, the first light shielding member is made of an inorganic material.

In a possible embodiment of the present disclosure, the first light shielding member is made of one or more materials selected from the group consisting of titanium, molybdenum, aluminum, silver and copper.

In a possible embodiment of the present disclosure, the display substrate further includes a light shielding pattern arranged between the spacer and the planarization layer, an orthogonal projection of the spacer onto the base substrate is arranged within an orthogonal projection of the light shielding pattern onto the base substrate, and a boundary of the orthogonal projection of the spacer onto the base substrate is spaced apart from a boundary of the orthogonal projection of the light shielding pattern onto the base substrate by a distance of 0 μm to 0.8 μm.

In a possible embodiment of the present disclosure, an auxiliary pattern is further arranged between the light shielding pattern and the spacer, the orthogonal projection of the spacer onto the base substrate is arranged within an orthogonal projection of the auxiliary pattern onto the base substrate, and the boundary of the orthogonal projection of the spacer onto the base substrate is spaced apart from a boundary of the orthogonal projection of the auxiliary pattern onto the base substrate by a distance of 0 μm to 0.8 μm.

In a possible embodiment of the present disclosure, the boundary of the orthogonal projection of the light shielding pattern onto the base substrate is spaced apart from the boundary of the orthogonal projection of the auxiliary pattern onto the base substrate by a distance of 0 μm to 0.4 μm.

In a possible embodiment of the present disclosure, the light shielding pattern is made of one or more materials selected from the group consisting of titanium, molybdenum, aluminum, silver and copper.

In a possible embodiment of the present disclosure, a boundary of an orthogonal projection of a first surface of the spacer at a side away from the base substrate onto the base substrate is spaced apart from a boundary of an orthogonal projection of a second surface of the spacer at a side close to the base substrate onto the base substrate by a distance of 0 μm to 0.4 μm, and a maximum width of the second surface is less than or equal to 2 μm.

In a possible embodiment of the present disclosure, a ratio of a height to the maximum width of the spacer is greater than 1.5.

In another aspect, the present disclosure provides in some embodiments a method for manufacturing a display substrate, including: providing a base substrate; forming a plurality of first light shielding members on the base substrate, the first light shielding member extending in a first direction; forming a plurality of light filtering units at a side of the first light shielding member away from the base substrate, the plurality of light filtering units being arranged at intervals; forming a plurality of second light shielding members, each second light shielding member being filled in a gap between adjacent light filtering units, the second light shielding member extending in a second direction, and the first direction intersecting the second direction; forming a planarization layer at a side of the plurality of light filtering units and the plurality of second light shielding members away from the base substrate; and forming a spacer at a side of the planarization layer away from the base substrate.

In a possible embodiment of the present disclosure, an opposing substrate of the display substrate includes a gate line and a data line, the first direction is an extension direction of the data line, and the second direction is an extension direction of the gate line.

In a possible embodiment of the present disclosure, the forming the plurality of first light shielding members includes: forming a metal thin film on the base substrate; and patterning the metal thin film to form the plurality of first light shielding members.

In a possible embodiment of the present disclosure, the method further includes: forming a light shielding pattern between the spacer and the planarization layer, an orthogonal projection of the spacer onto the base substrate being arranged within an orthogonal projection of the light shielding pattern onto the base substrate; and forming an auxiliary pattern between the light shielding pattern and the spacer.

In a possible embodiment of the present disclosure, the forming the spacer, the light shielding pattern and the auxiliary pattern specifically includes: forming a light-shielding metal layer on the planarization layer; forming an inorganic insulation layer on the light-shielding metal layer; forming a spacer material layer on the inorganic insulation layer; forming a hard mask layer on the spacer material layer; forming a photoresist layer on the hard mask layer; exposing and developing the photoresist layer to form a photoresist pattern; etching the hard mask layer with the photoresist pattern as a mask to form a first hard mask pattern; etching the light-shielding metal layer, the inorganic insulation layer and the spacer material layer with the first hard mask pattern as a mask to form the light shielding pattern, the auxiliary pattern, and a spacer transition pattern respectively; etching the photoresist pattern and the first hard mask pattern to reduce a size of the first hard mask pattern, so as to form a second hard mask pattern; etching the spacer transition pattern with the second hard mask pattern as a mask to form the spacer; and removing the second hard mask pattern and the remaining photoresist.

The present disclosure has the following beneficial effects.

According to the embodiments of the present disclosure, a light shielding structure of the display substrate includes the first light shielding members extending in the first direction and the second light shielding members extending in the second direction, and the second light shielding member is filled in a gap between the adjacent light filtering units, so as to improve flatness of a surface of the light filtering unit at a side away from the base substrate and reduce a thickness of the planarization layer. As a result, it is able to shorten an optical path from a backlight side to a light-exiting side, thereby to prevent the occurrence of crosstalk. In addition, it is unnecessary to increase a size of the light shielding member, thereby to improve an aperture ratio of the display substrate.

### BRIEF DESCRIPTION OF THE DRAWINGS

FIG. 1 is a schematic view showing a pixel size of a high-PPI display product;

FIGS. 2 and 3 are schematic views showing angles at which crosstalk occurs for the display product;

FIG. 4 is a schematic view showing an ideal light shielding member;

FIG. 5 is a schematic view showing an actual light shielding member;

FIGS. 6 to 11 are schematic diagrams showing the manufacture of a display substrate according to one embodiment of the present disclosure;

FIG. 12 is a schematic view showing of a post spacer arranged on a color film substrate;

FIG. 13 is a schematic view showing a situation where a dark-state leakage occurs for the display product;

FIGS. 14 and 15 are schematic views showing the display product with a light shielding pattern; and

FIGS. 16 to 28 are schematic views showing the manufacture of the display substrate according to one embodiment of the present disclosure.

### REFERENCE SIGN LIST

11 red light filtering unit
12 green light filtering unit
13 blue light filtering unit
14 light shielding member
16 base substrate
17 planarization layer
20 liquid crystal layer
21 buffer layer
22 light-shielding metal layer
23 inorganic insulation layer
24 spacer material layer
25 hard mask layer
26 photoresist pattern
30 alignment layer
35 light shielding pattern
141 first light shielding member
142 second light shielding member
221 light shielding pattern
231 auxiliary pattern
241 spacer transition pattern
242 spacer
251 first hard mask pattern
252 second hard mask pattern

### DETAILED DESCRIPTION

In order to make the objects, the technical solutions and the advantages of the present disclosure more apparent, the present disclosure will be described hereinafter in a clear and complete manner in conjunction with the drawings and embodiments.

Unless otherwise defined, such a word “include” or “including” or any other variations involved in the embodiments of the present disclosure intends to provide non-exclusive coverage, i.e., it means “includes, but not limited to”. Such expressions as “one embodiment”, “some embodiments”, “exemplary embodiments”, “example”, “specific example” and “some examples” intend to indicate that the features, structures or materials are contained in at least one embodiment or example of the present disclosure, rather than referring to an identical embodiment or example. In addition, the features, structures or materials may be combined in any embodiment or embodiments in an appropriate manner.

In addition, such words as “first” and “second” are merely used to differentiate different components rather than to represent any order, number or importance, i.e., they are used to implicitly or explicitly indicate that there is at least one component. Further, such a phrase as “a plurality of” is used to indicate that there are at least two components, unless otherwise specified.

Such words as “on”, “under”, “front”, “after”, “vertical”, “horizontal”, “upper”, “lower”, “inside” and “outside” may indicate directions or positions as viewed in the drawings, and they are merely used to facilitate the description in the present disclosure, rather than to indicate or imply that a device or member must be arranged or operated at a specific position.

Such a word as “about”, “approximately” or “similar” involved in the embodiments of the present disclosure relates to a value thereafter or an average value within an acceptable deviation range. The acceptable deviation range is determined in accordance with an error related to the discussed measurement or the measurement of a particular quantity (i.e., a limitation of a measurement system).

Such a word as “parallel”, “vertical” and “equal” involved in the embodiments of the present disclosure relates to a described situation and a situation similar thereto. The similar situation is within an acceptable deviation range, and the acceptable deviation range is determined in accordance with an error related to the discussed measurement or the measurement of a particular quantity (i.e., the limitation of the measurement system). For example, “parallel” includes “exactly parallel” and “approximately parallel”, and the acceptable deviation range of “approximately parallel” includes ±5°. For another example, “vertical” includes “exactly vertical” and “approximately vertical”, and the acceptable deviation range of “approximately vertical” includes ±5°. For yet another example, “equal” includes “exactly equal” and “approximately equal”, and the acceptable deviation range of “approximately equal” includes ±10%.

It should be appreciated that, when a layer or element is arranged on another layer or a substrate, it means that the layer or element is directly arranged on the other layer or the substrate, or there is an intermediate layer therebetween.

The present disclosure will be described hereinafter illustratively with reference to the sectional views and/or planar views. In these drawings, for clarification, a thickness of a layer and an area of a region are enlarged. Hence, any change in a shape caused by the manufacturing technology and/or a manufacturing tolerance may be taken into consideration, and the shape of the region shall not be limited to that shown in the drawings. For example, a regular etching region shown in the drawings is usually curved. In a word, the drawings are for illustrative purposes only, and the shape of the region in the drawings does not intend to reflect an actual shape.

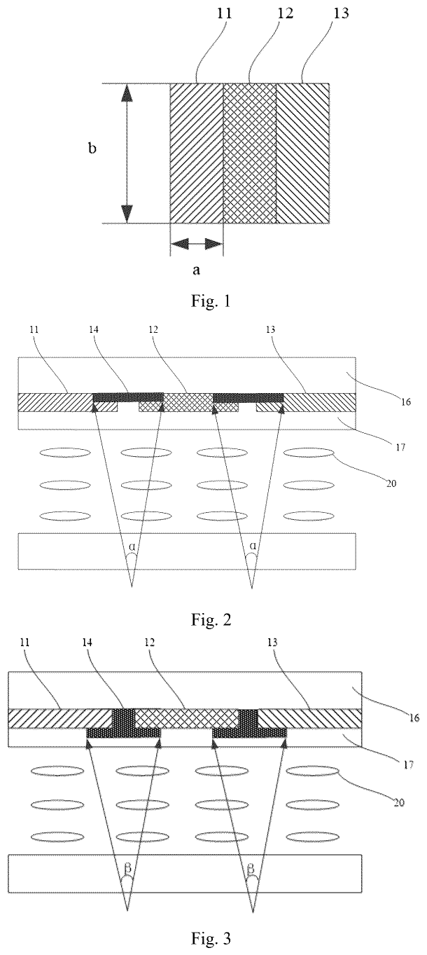

With the development of the display technology, a resolution of a liquid crystal display product gradually increases from 200 PPI to 500 PPI, 1000 PPI, 1500 PPI, or even 2000 PPI. For the display product having a resolution of 2000 PPI, as shown in FIG. 1, a size of each pixel is small. For example, for a high PPI Virtual Reality (VR) product, each pixel has a length b of about 12.6 μm and a width a of about 4.2 μm.

Along with an increase in the PPI of a liquid crystal display product, a pixel size becomes smaller and the risk of crosstalk becomes larger. As shown in FIGS. 2 and 3, the liquid crystal display product includes an array substrate, a color film substrate arranged opposite to the array substrate, and a liquid crystal layer 20 arranged between the array substrate and the color film substrate. The color film substrate includes a base substrate 16, and a red light filtering unit 11, a green light filtering unit 12, a blue light filtering unit 13, a light shielding member 14 and a planarization layer 17 arranged on the base substrate 16. As shown in FIGS. 2 and 3, angles at which crosstalk occurs (including a and B) are affected by a width of the light shielding member and an optical distance (a distance that light has travelled). The larger the optical distance (from the backlight to a surface of the light filtering unit close to the base substrate 16), the smaller the angle.

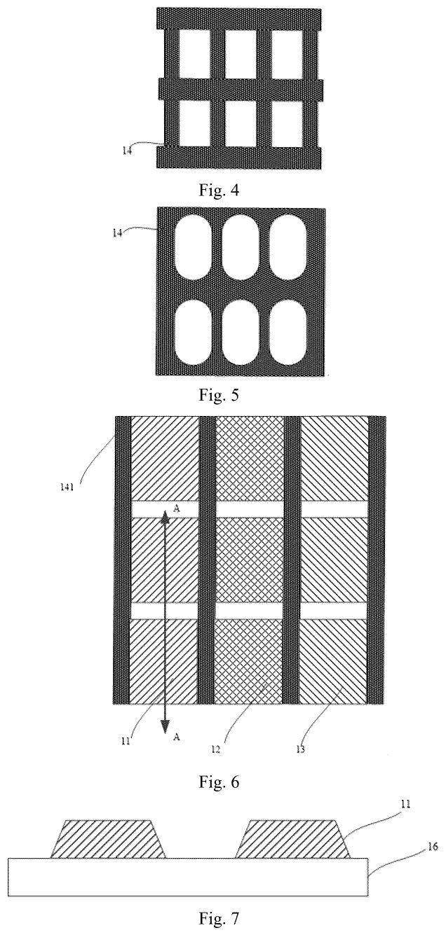

In addition, in the related art, as shown in FIG. 3, during the manufacture of the color film substrate, when the light filtering units are formed before the light shielding member 14, the light shielding member 14 has a small thickness, so it is impossible to fill and level up a gap between the light filtering units, and at this time it is necessary to increase a thickness of the planarization layer 17. In this regard, the optical distance increases, and the angle at which the crosstalk occurs decreases, so it is impossible to prevent the occurrence of crosstalk. In addition, FIG. 4 shows an ideal light shielding member in the form of a grid. However, in the case of high PPI, a small-size grid needs to be formed. Due to edge diffraction during the exposure, it is impossible to form a regular grid-like aperture pattern, and abnormalities occur at edges and corners of the grid, as shown in FIG. 5. At this time, an aperture ratio decreases and light leakage occurs. To be specific, the edge and corner of the light shielding member are not straight enough, and there is an angle between a polarization direction of a polarizer and each of the edge and corner, so the dark-state leakage occurs.

An object of the present disclosure is to provide a display substrate and a manufacturing method thereof, so as to prevent the occurrence of crosstalk, and improve an aperture ratio of the display substrate.

The present disclosure provides in some embodiments a display substrate, which includes: a base substrate; a plurality of first light shielding members arranged on the base substrate and extending in a first direction; a plurality of light filtering units and a plurality of second light shielding members arranged at a side of the first light shielding member away from the base substrate, the plurality of light filtering units being arranged at intervals, the second light shielding member being filled in a gap between adjacent light filtering units, the second light shielding member extending in a second direction, and the first direction intersecting the second direction; a planarization layer arranged at a side of the plurality of light filtering units and the plurality of second light shielding members away from the base substrate; and a spacer arranged at a side of the planarization layer away from the base substrate.

According to the embodiments of the present disclosure, a light shielding structure of the display substrate includes the first light shielding members extending in the first direction and the second light shielding members extending in the second direction, and the second light shielding member is filled in a gap between the adjacent light filtering units, so as to improve flatness of a surface of the light filtering unit at a side away from the base substrate and reduce a thickness of the planarization layer. As a result, it is able to shorten an optical path from a backlight side to a light-exiting side, thereby to prevent the occurrence of crosstalk. In addition, it is unnecessary to increase a size of the light shielding member, thereby to improve an aperture ratio of the display substrate.

In addition, the straight light shielding member, rather than the grid-like light shielding member, is formed, so it is able to prevent the occurrence of edge diffraction during the exposure, and form the regular grid-like aperture pattern, thereby to further increase the aperture ratio of the display substrate, and prevent the occurrence of light leakage.

In the embodiments of the present disclosure, as shown in FIG. 6, a first light shielding member 141 is firstly formed on the base substrate in such a manner as to extend in an extension direction of a data line in a liquid crystal display product. Of course, the first light shielding member 141 may also extend in an extension direction of a gate line in the liquid crystal display product. In order to ensure better flatness after the formation of the light filtering units, the first light shielding member is made of metal. As compared with an organic light shielding material, it is able for a metal layer to provide a better light shielding effect even with a small thickness. The thickness of the first light shielding member is not greater than 500 angstroms. In order to prevent the occurrence of diffraction during the exposure, the first light shielding member is made of one or more selected from the group consisting of titanium, molybdenum, aluminum, silver and copper, i.e., one or more of elemental metals, alloys, or metal oxides.

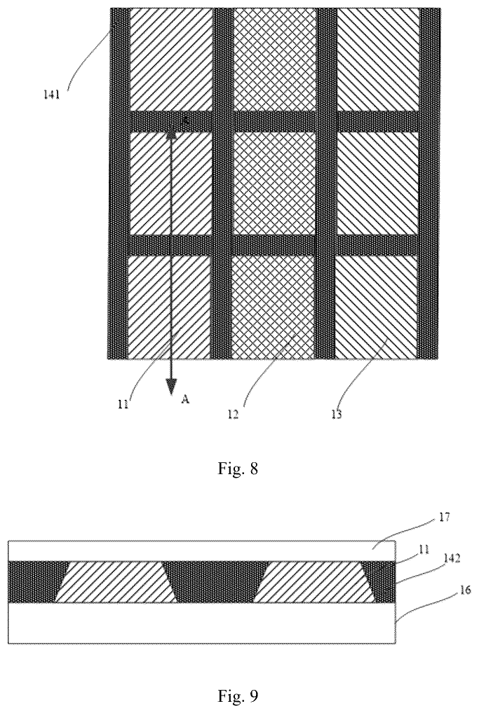

Next, as shown in FIGS. 6 and 7 (FIG. 7 is a sectional view of the display substrate along line AA in FIG. 6), light filtering units are formed on the base substrate. The light filtering units include a red light filtering unit 11, a green light filtering unit 12 and a blue light filtering unit 13. There is a gap between adjacent light filtering units, and an extension direction of the gap is parallel to the second direction. During the formation of the light filtering units, surfaces of the light filtering units away from the base substrate 16 are flush with each other. In a possible embodiment of the present disclosure, surfaces of the light filtering units away from the base substrate 16 are also flush with each other in a region where the light filtering unit overlaps with the first light shielding member 141. In the embodiments of the present disclosure, an edge of the light filtering unit extending in the second direction is of a straight shape through optical proximity correction (OPC). In some embodiments of the present disclosure, the light filtering unit is provided with a straight edge when an OPC value is 0.8 μm.

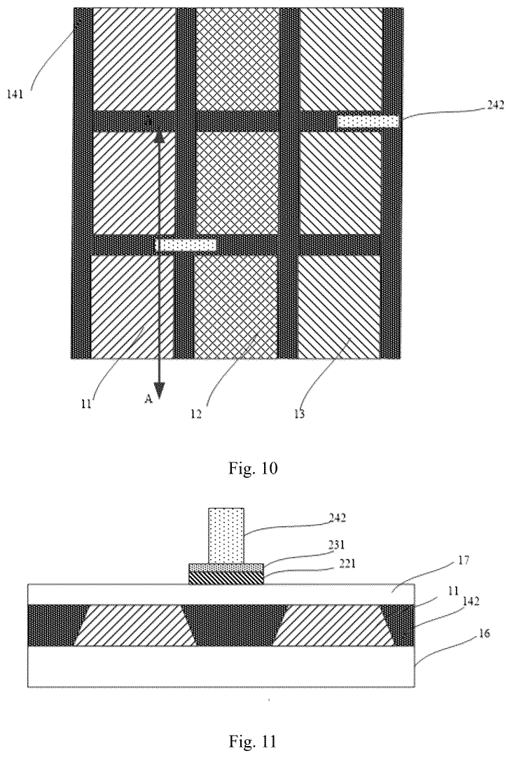

After the formation of the light filtering units, as shown in FIGS. 8 and 9 (FIG. 9 is a sectional view of the display substrate along line AA in FIG. 8), the second light shielding member 142 is formed in the gap between the adjacent light filtering units, and an extension direction of the second light shielding member 142 is parallel to the second direction. The second light shielding member 142 is filled in the gap between the adjacent light filtering units, and a thickness of the second light shielding member 142 is the same as the thickness of the light filtering unit. Surfaces of the plurality of light filtering units and the plurality of second light shielding members at a side away from the base substrate have roughness Ra of less than or equal to 0.5 μm, or a height difference between the light filtering unit and the adjacent second light shielding member in a direction perpendicular to the base substrate and away from the base substrate is less than 0.5 μm, e.g., less than 0.2 μm. In this way, the surfaces of the plurality of light filtering units and the plurality of second light shielding members at a side away from the base substrate are substantially flush with each other, so as to reduce a thickness of the planarization layer 17 formed subsequently. In the related art, the thickness of the planarization layer is generally 2 μm or more. However, in the embodiments of the present disclosure, the thickness of the planarization layer 17 is less than 1 μm, e.g., 0.6 μm to 1 μm. When the thickness of the planarization layer is reduced, it is able to reduce the optical distance from the backlight to the light-exiting side, and prevent the occurrence of crosstalk without any increase in the size of the light shielding member, thereby to increase the aperture ratio of the display substrate.

The roughness Ra is a commonly-used surface roughness index, and it represents an average surface roughness value per unit length. The surface roughness is obtained through one or more of scanning electron microscope (SEM), atomic force microscope (AFM) or roughness meter.

In the embodiments of the present disclosure, the first light shielding member 141 and the second light shielding member 142 are formed through two steps, and it is unnecessary to form a grid-like light shielding pattern. Hence, it is able to prevent the occurrence of edge diffraction during the exposure, and form the regular grid-like aperture pattern, thereby to further increase the aperture ratio of the display substrate.

In the embodiments of the present disclosure, the first direction is an extension direction of the data line in the liquid crystal display product, and the second direction is an extension direction of the gate line in the liquid crystal display product and perpendicular to the first direction. Alternatively, the first direction is the extension direction of the gate line in the liquid crystal display product, and the second direction is the extension direction of the data line in the liquid crystal display product and perpendicular to the first direction.

In the embodiments of the present disclosure, the first light shielding member 141 is of a straight shape, and overlaps with the light filtering unit at a small overlapping area. Hence, after the formation of the light filtering units at a side of the first light shielding member 141 away from the base substrate, the surface of the light filtering unit away from the base substrate is provided with better flatness.

Usually, the liquid crystal display product includes a color film substrate and an array substrate. The display substrate in the embodiments of the present embodiment may be the color film substrate.

Apart from the color film substrate and the array substrate, the liquid crystal display product further includes a spacer for supporting a liquid crystal cell, so that the liquid crystal cell has a uniform thickness. As shown in FIGS. 10 and 11 (FIG. 11 is a sectional view of the display substrate along line AA in FIG. 10), the spacer 242 is arranged on the planarization layer 17.

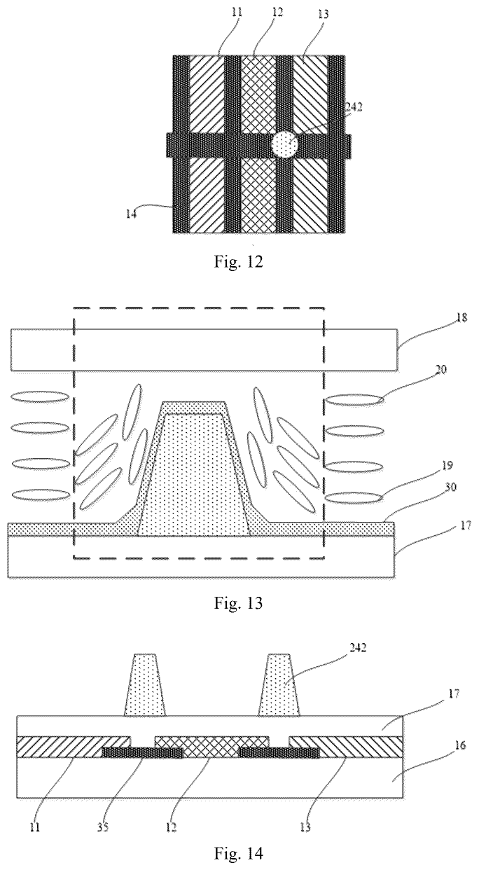

As shown in FIG. 12, in the related art, generally the spacer 242 is of a post-like structure. Due to the thickness of the spacer 242, after the formation of an alignment layer 30, as shown in FIG. 13, the alignment layer 30 is accumulated around the spacer 242, resulting in a disorder of the alignment of the liquid crystals around the spacer 242, and a dark state leakage occurs at a position indicated by a dashed box in FIG. 14. Hence, as shown in FIGS. 14 and 15, a light shielding pattern 35 needs to be added below the spacer 242 to shield the light. At this time, the aperture ratio of the display product is decreased, and thereby the brightness and the display quality are adversely affected.

During the manufacture of the display product, a size of the light shielding pattern 35 must be greater than a critical size of a bottom of the spacer 242, and a certain allowance needs to be provided for the alignment offset of the liquid crystal cell as well as a light leakage distance. The aperture ratio of the display product is adversely affected by an increase in the size of the light shielding pattern 35.

In the structure as shown in FIG. 14, BM CD=PS Bottom CD+2*light leakage

$$distance + 2 \text{?} ,$$

$$\text{?} \text{indicates text missing or illegible when filed}$$

where BM CD is the critical size of the light shielding pattern 35, PS Bottom CD is the critical size of an end of the spacer 242 close to the color film substrate, BM tol is a process offset of the light shielding pattern 35, PS tol is a process offset of the spacer, and ol is an alignment offset. Obviously, the critical size of the light shielding pattern 35 is large.

In order to prevent the overall aperture ratio of the display product from being decreased due to the large critical size of the light shielding pattern 35, a self-alignment process is used to form the spacer. After the formation of the planarization layer of the color film substrate, a light-shielding metal layer is formed on the planarization layer, a spacer material layer is formed on the light-shielding metal layer, a hard mask layer is formed on the spacer material layer, and a photoresist pattern is formed on the hard mask layer. The hard mask layer is etched with the photoresist pattern as a mask to form a hard mask pattern, and the spacer material layer and the light-shielding metal layer are dry-etched with the hard mask pattern as a mask to form the spacer and the light shielding pattern. In this way, it is unnecessary to align the light shielding pattern with the spacer and provide the light shielding pattern with a smaller size, thereby to increase the aperture ratio of the display device.

At this time, BM CD=PS Bottom CD+2*light leakage distance+2*\sqrt{BM tol²}. When ol=0.6 μm and PS tol=0.5 μm, BM CD is reduced by 2*0.43=0.86 μm.

However, in a current high-PPI (PPI is not less than 2000) display product, generally a maximum width of the spacer is less than 1 μm, and a height of the spacer is greater than 1.6 μm, i.e., a ratio of the height to the width of the spacer (namely, a depth-to-width ratio) is greater than 1.5. When an oblique force is applied to the spacer during a pre-washing process of the alignment layer (i.e., washing with a brush, so as to large particulates on the surface and improve surface characteristics of the planarization layer, thereby ensure the anchoring of the alignment layer), the spacer easily falls off, and it is impossible to form a stable liquid crystal cell. This is because, the width of the spacer is too small, and the height of the spacer is too large. When a lateral force is applied thereto, an intensity of pressure is too large. In addition, there is an insufficient adhesion force between the spacer and the light shielding pattern. Hence, the spacer easily falls off.

In the embodiments of the present disclosure, as shown in FIG. 28, the display substrate further includes a light shielding pattern 221 arranged between the spacer 242 and the planarization layer 17, and the orthogonal projection of the spacer 242 onto the base substrate is arranged within an orthogonal projection of the light shielding pattern 221 onto the base substrate.

In order to prevent the spacer from falling off, the display substrate further includes an auxiliary pattern 231 arranged between the light shielding pattern 221 and the spacer 242. Through the auxiliary pattern 231, it is able to increase the adhesion between the spacer 242 and the display substrate, thereby to prevent the spacer 242 from falling off in the pre-washing process of the alignment layer. The auxiliary pattern 231 is made of silicon nitride or silicon oxide which are common materials for the manufacture of the display substrate. When the auxiliary pattern 231 is made of silicon nitride or silicon oxide, it is able to form the auxiliary pattern through an existing film-forming device, thereby to reduce the manufacture cost of the display substrate. Tests show that, when the auxiliary pattern 231 is made of silicon nitride or silicon oxide, the adhesion between the spacer and the auxiliary pattern is 5B, and the spacer may not fall of after the pre-washing process of the alignment layer.

In the embodiments of the present disclosure, the depth to width ratio of the spacer 242 is relatively large because the adhesion between the spacer 242 and the auxiliary pattern 231 is significantly increased. In some embodiments of the present disclosure, the ratio of the height to the maximum width of the spacer 242 is greater than 1.5, so as to reduce the size of the spacer 242 as well as the size of the light shielding pattern 221, thereby to increase the aperture ratio of the display substrate. In addition, the critical size of the spacer 242 is less than or equal to 1.0 μm, and the height is greater than or equal to 1.6 μm, so as to meet the requirement of the high PPI display product.

In the embodiments of the present disclosure, the light shielding pattern 221 needs to shield the light leakage around the spacer (the dark state light leakage in the dashed box in FIG. 13). Hence, as shown in FIG. 28, a critical size d1 of the light shielding pattern 221 needs to be greater than the critical size d2 of the spacer 242, i.e., the orthogonal projection of the spacer onto the base substrate is arranged within the orthogonal projection of the light shielding pattern onto the base substrate. In some embodiments of the present disclosure, a boundary of the orthogonal projection of the spacer onto the base substrate is spaced apart from a boundary of the orthogonal projection of the light shielding pattern onto the base substrate by a distance of 0 μm to 0.8 μm. In this way, it is able for the light shielding pattern 221 to shield the light leakage around the spacer 242 in a better manner.

In some embodiments of the present disclosure, the orthogonal projection of the spacer 242 onto the base substrate is arranged within an orthogonal projection of the auxiliary pattern 231 onto the base substrate, and the boundary of the orthogonal projection of the spacer 242 onto the base substrate is spaced apart from a boundary of the orthogonal projection of the auxiliary pattern 231 onto the base substrate by a distance of 0 μm to 0.8 μm, e.g., 0 μm to 0.4 μm, so as to ensure the adhesion between the spacer 242 and the auxiliary pattern 231.

In the embodiments of the present disclosure, the light shielding pattern 221 is made of one or more selected from the group consisting of titanium, molybdenum, aluminum, silver and copper, i.e., one or more of elemental metals, alloys, or metal oxides. For example, the light shielding pattern 221 is made of Mo, so as to achieve a better light shielding effect at a smaller thickness. In order to reduce the overall thickness of the display substrate, a thickness of the light shielding pattern 221 is not greater than 500 angstroms. Further, in the embodiments of the present disclosure, when the light shielding pattern 221 is formed through dry etching, Mo is relatively easy to be etched.

In some embodiments of the present disclosure, a boundary of an orthogonal projection of a first surface of the spacer 242 at a side away from the base substrate onto the base substrate is spaced apart from a boundary of an orthogonal projection of a second surface of the spacer 242 at a side close to the base substrate onto the base substrate by a distance of 0 μm to 0.4 μm, and a maximum width of the second surface is less than or equal to 2 μm. In this way, the orthogonal projection of the first surface onto the base substrate coincides with, or substantially coincides with, the orthogonal projection of the second surface onto the base substrate, so as to reduce a size of an end of the 242 close to the base substrate as well as a size of the light shielding pattern 242, thereby to increase the aperture ratio of the display substrate.

The present disclosure further provides in some embodiments a display device, which includes the above-mentioned display substrate.

The display device includes, but not limited to, a radio frequency unit, a network module, an audio output unit, an input unit, a sensor, a display unit, a user input unit, an interface unit, a memory, a processor, and a power source. It should be appreciated that, the display device shall not be limited thereto, i.e., it may include more or fewer members, or some members may be combined, or the members may be arranged in different modes. In the embodiments of the present disclosure, the display device includes, but not limited to, display, mobile phone, flat-panel computer, television, wearable electronic device or navigator.

The display device may be any product or member having a display function, such as a liquid crystal television, a liquid crystal display, a digital photo frame, a mobile phone, or a tablet computer. The display device further includes a flexible circuit board, a printed circuit board, and a back plate.

The display device further includes, in addition to the above-mentioned display substrate, an array substrate arranged opposite to the display substrate to form a cell, and a liquid crystal layer arranged between the display substrate and the array substrate. The array substrate includes a base substrate, and a thin film transistor array layer, a pixel electrode layer and a common electrode layer arranged on the base substrate. The thin film transistor array layer includes an active layer, a gate insulation layer, a gate electrode layer, a source and drain metal layer, an interlayer insulation layer, etc.

The present disclosure further provides in some embodiments a method for manufacturing the above-mentioned display substrate, which includes: providing a base substrate; forming a plurality of first light shielding members on the base substrate, the first light shielding member extending in a first direction; forming a plurality of light filtering units at a side of the first light shielding member away from the base substrate, the plurality of light filtering units being arranged at intervals; forming a plurality of second light shielding members, each second light shielding member being filled in a gap between adjacent light filtering units, the second light shielding member extending in a second direction, and the first direction intersecting the second direction; forming a planarization layer at a side of the plurality of light filtering units and the plurality of second light shielding members away from the base substrate; and forming a spacer at a side of the planarization layer away from the base substrate.

In the embodiments of the present disclosure, a light shielding structure of the display substrate includes the first light shielding members extending in the first direction and the second light shielding members extending in the second direction, and the second light shielding member is filled in a gap between the adjacent light filtering units, so as to improve flatness of a surface of the light filtering unit at a side away from the base substrate and reduce a thickness of the planarization layer. As a result, it is able to shorten an optical path from a backlight side to a light-exiting side, thereby to prevent the occurrence of crosstalk. In addition, it is unnecessary to increase a size of the light shielding member, thereby to improve an aperture ratio of the display substrate.

In addition, the straight light shielding member, rather than the grid-like light shielding member, is formed, so it is able to prevent the occurrence of edge diffraction during the exposure, and form the regular grid-like aperture pattern, thereby to further increase the aperture ratio of the display substrate, and prevent the occurrence of light leakage.

In some embodiments of the present disclosure, the method includes the following steps.

As shown in FIG. 6, a metal thin film is formed on the base substrate, and then etched to form a first light shielding member 141. The first light shielding member 141 extends along an extension direction of a data line of a liquid crystal display product, or along a direction of a gate line of the liquid crystal display product. In the embodiments of the present disclosure, in order to ensure the flatness after the formation of the light filtering units, the first light shielding member is made of one or more selected from the group consisting of titanium, molybdenum, aluminum, silver and copper, i.e., one or more of elemental metals, alloys, or metal oxides. As compared with an organic shielding material, when the first light shielding member is made of metal, it is able to provide an excellent light shielding effect at a smaller thickness. The thickness of the first light shielding member is not greater than 500 angstroms. In order to prevent the occurrence of diffraction during the exposure, the first light shielding member is made of such a metal as Ti or Mo with a small degree of depolarization.

Next, as shown in FIGS. 6 and 7 (FIG. 7 is a sectional view of the display substrate along line AA in FIG. 6), light filtering units are formed on the base substrate. The light filtering units include a red light filtering unit 11, a green light filtering unit 12 and a blue light filtering unit 13. There is a gap between adjacent light filtering units, and an extension direction of the gap is parallel to the second direction. During the formation of the light filtering units, surfaces of the light filtering units away from the base substrate 16 are flush with each other. In a possible embodiment of the present disclosure, surfaces of the light filtering units away from the base substrate 16 are also flush with each other in a region where the light filtering unit overlaps with the first light shielding member 141. In the embodiments of the present disclosure, an edge of the light filtering unit extending in the second direction is of a straight shape through optical proximity correction (OPC). In some embodiments of the present disclosure, the light filtering unit is provided with a straight edge when an OPC value is 0.8 μm.

After the formation of the light filtering units, as shown in FIGS. 8 and 9 (FIG. 9 is a sectional view of the display substrate along line AA in FIG. 8), the second light shielding member 142 is formed in the gap between the adjacent light filtering units, and an extension direction of the second light shielding member 142 is parallel to the second direction. The second light shielding member 142 is filled in the gap between the adjacent light filtering units, and a thickness of the second light shielding member 142 is the same as the thickness of the light filtering unit. Surfaces of the plurality of light filtering units and the plurality of second light shielding members at a side away from the base substrate have roughness Ra of less than or equal to 0.5 μm, or a height difference between the light filtering unit and the adjacent second light shielding member in a direction perpendicular to the base substrate and away from the base substrate is less than 0.5 μm, e.g., less than 0.2 μm. In this way, the surfaces of the plurality of light filtering units and the plurality of second light shielding members at a side away from the base substrate are substantially flush with each other, so as to reduce a thickness of the planarization layer 17 formed subsequently. In the related art, the thickness of the planarization layer is generally 2 μm or more. However, in the embodiments of the present disclosure, the thickness of the planarization layer 17 is less than 1 μm, e.g., 0.6 μm to 1 μm. When the thickness of the planarization layer is reduced, it is able to reduce the optical distance from the backlight to the light-exiting side, and prevent the occurrence of crosstalk without any increase in the size of the light shielding member, thereby to increase the aperture ratio of the display substrate.

The roughness Ra is a commonly-used surface roughness index, and it represents an average surface roughness value per unit length. The surface roughness is obtained through one or more of scanning electron microscope (SEM), atomic force microscope (AFM) or roughness meter.

In the embodiments of the present disclosure, the first light shielding member 141 and the second light shielding member 142 are formed through two steps, and it is unnecessary to form a grid-like light shielding pattern. Hence, it is able to prevent the occurrence of edge diffraction during the exposure, and form the regular grid-like aperture pattern, thereby to further increase the aperture ratio of the display substrate.

In the embodiments of the present disclosure, the first direction is an extension direction of the data line in the liquid crystal display product, and the second direction is an extension direction of the gate line in the liquid crystal display product and perpendicular to the first direction. Alternatively, the first direction is the extension direction of the gate line in the liquid crystal display product, and the second direction is the extension direction of the data line in the liquid crystal display product and perpendicular to the first direction.

In the embodiments of the present disclosure, the first light shielding member 141 is of a straight shape, and overlaps with the light filtering unit at a small overlapping area. Hence, after the formation of the light filtering units at a side of the first light shielding member 141 away from the base substrate, the surface of the light filtering unit away from the base substrate is provided with better flatness.

In some embodiments of the present disclosure, the method further includes forming a light shielding pattern between the spacer and the planarization layer, and the orthogonal projection of the spacer onto the base substrate is arranged within an orthogonal projection of the light shielding pattern onto the base substrate.

In order to prevent the spacer from falling off, the method further includes forming an auxiliary pattern between the light shielding pattern and the spacer. Through the auxiliary pattern, it is able to increase the adhesion between the spacer and the display substrate, thereby to prevent the spacer from falling off in the pre-washing process of the alignment layer. The auxiliary pattern is made of silicon nitride or silicon oxide which are common materials for the manufacture of the display substrate. When the auxiliary pattern is made of silicon nitride or silicon oxide, it is able to form the auxiliary pattern through an existing film-forming device, thereby to reduce the manufacture cost of the display substrate. Tests show that, when the auxiliary pattern is made of silicon nitride or silicon oxide, the adhesion between the spacer and the auxiliary pattern is 5B, and the spacer may not fall of after the pre-washing process of the alignment layer.

In some embodiments of the present disclosure, the method includes the following steps.

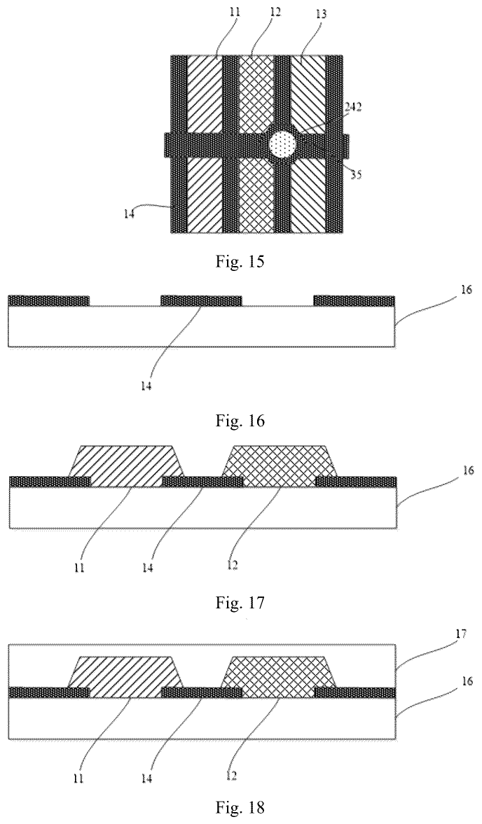

As shown in FIG. 16, a base substrate 16 is provided, and a light shielding member 14 is formed on the base substrate 16.

As shown in FIG. 17, light filtering units are formed on the base substrate 16, and the light filtering units include a red light filtering unit 11 and a green light filtering unit 12.

As shown in FIG. 18, a planarization layer 17 is formed at a side of the light filtering units away from the base substrate 16.

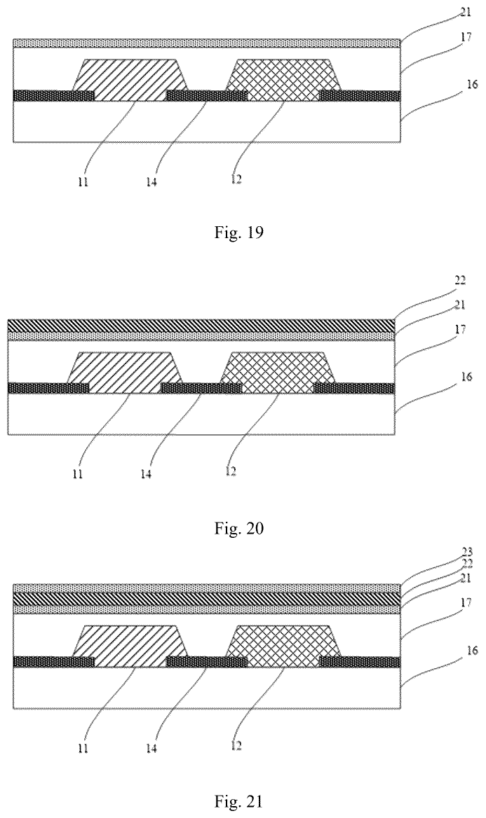

As shown in FIG. 19, a buffer layer 21 is formed on the planarization layer 17, so as to protect the planarization layer 17 from being damaged in a subsequent process. The buffer layer 21 is made of silicon nitride or silicon oxide, and a thickness thereof is not greater than 500 angstroms.

As shown in FIG. 20, a light-shielding metal layer 22 is formed on the buffer layer 21. The light-shielding metal layer 22 is made of Mo, and a thickness thereof is not greater than 500 angstroms.

As shown in FIG. 21, an inorganic insulation layer 23 is formed on the light-shielding metal layer 22. The inorganic insulation layer 23 is made of silicon nitride or silicon oxide.

As shown in FIG. 22, a spacer material layer 24 is formed on the inorganic insulation layer 23. An entire surface of the spacer material layer 24 is subjected to exposure.

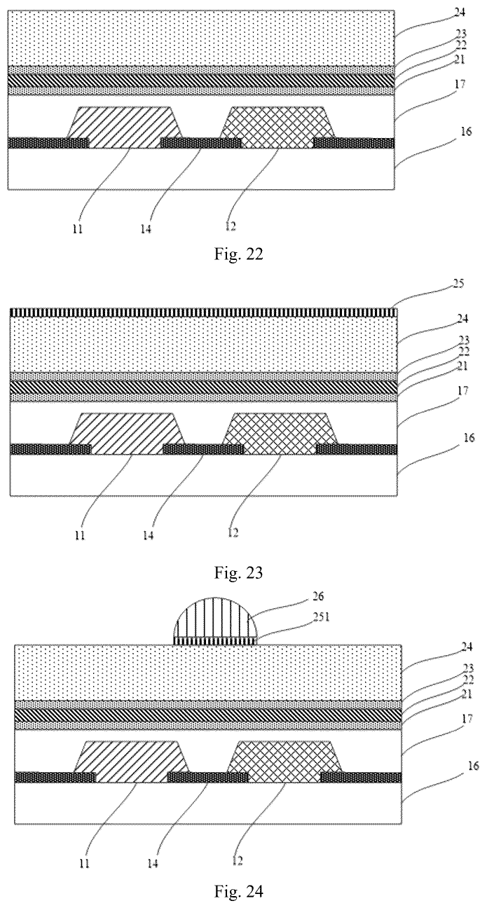

As shown in FIG. 23, a hard mask layer 25 is formed on the spacer material layer 24, and a material of the hard mask layer 25 depends on the material of the light-shielding metal layer 22 and the material of the inorganic insulation layer 23, because the light-shielding metal layer 22 and the inorganic insulation layer 23, rather than the hard mask layer 25, need to be etched in a subsequent dry-etching process. When the light-shielding metal layer 22 is made of Mo and the inorganic insulation layer 23 is made of silicon nitride or silicon oxide, the hard mask layer 25 is made of ITO.

Next, a photoresist layer is formed on the hard mask layer 25, and then exposed and developed to form a photoresist pattern.

As shown in FIG. 24, the hard mask layer 25 is etched with the photoresist pattern 26 as a mask to form a first hard mask pattern 251 at a position corresponding to the spacer to be formed.

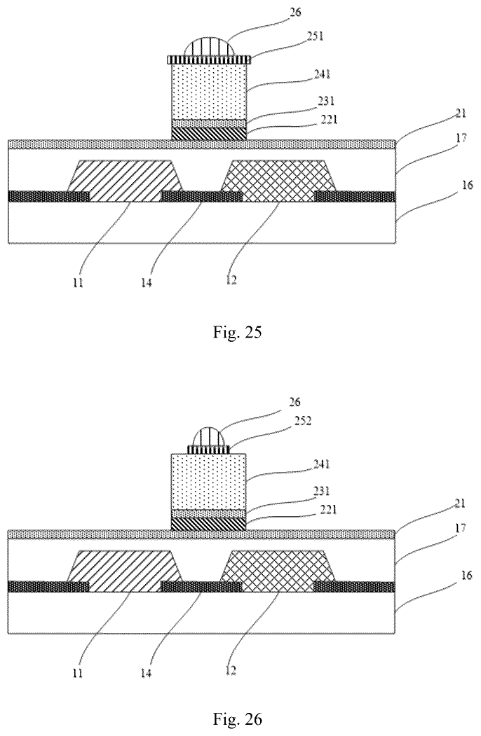

As shown in FIG. 25, the light-shielding metal layer 22, the inorganic insulation layer 23 and the spacer material layer 24 are etched with the first hard mask pattern 251 as a mask to form the light shielding pattern 221, the auxiliary pattern 231, and a spacer transition pattern 241 respectively. In the embodiments of the present disclosure, the light-shielding metal layer 22, the inorganic insulation layer 23 and the spacer material layer 24 are etched through dry etching, with an etching atmosphere as O₂ and Cl₂ for about 50 s +40 s, i.e., the layers are etched with O₂ for 50 s, and then with Cl₂ for 40 s.

In order to enable a size of the spacer to be smaller than a size of the light shielding pattern 221, as shown in FIG. 26, the photoresist pattern 26 and the first hard mask pattern 251 are etched to reduce a size of the first hard mask pattern 251, so as to form a second hard mask pattern 252.

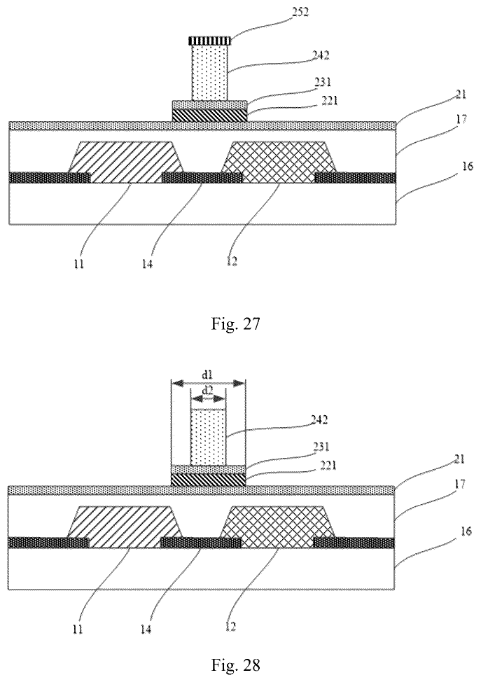

As shown in FIG. 27, the spacer transition pattern 241 is etched with the second hard mask pattern 252 as a mask to form the spacer 242. Specifically, the spacer transition pattern 241 is etched with O₂ for about 100 s.

As shown in FIG. 28, the second hard mask pattern 252 and the remaining photoresist are removed.

In the embodiments of the present disclosure, as shown in FIG. 28, the display substrate includes the auxiliary pattern 231 arranged between the light shielding pattern 221 and the spacer 242. Through the auxiliary pattern 231, it is able to increase the adhesion between the spacer 242 and the display substrate, thereby to prevent the spacer 242 from falling off in the pre-washing process of the alignment layer. The auxiliary pattern 231 is made of silicon nitride or silicon oxide which are common materials for the manufacture of the display substrate. When the auxiliary pattern 231 is made of silicon nitride or silicon oxide, it is able to form the auxiliary pattern through an existing film-forming device, thereby to reduce the manufacture cost of the display substrate. Tests show that, when the auxiliary pattern 231 is made of silicon nitride or silicon oxide, the adhesion between the spacer and the auxiliary pattern is 5B, and the spacer may not fall of after the pre-washing process of the alignment layer.

In the embodiments of the present disclosure, a depth to width ratio of the spacer 242 is relatively large because the adhesion between the spacer 242 and the auxiliary pattern 231 is significantly increased. In some embodiments of the present disclosure, the ratio of the height to the maximum width of the spacer 242 is greater than 1.5, so as to reduce the size of the spacer 242 as well as the size of the light shielding pattern 221, thereby to increase the aperture ratio of the display substrate.

In the embodiments of the present disclosure, the light shielding pattern 221 needs to shield the light leakage around the spacer (the dark state light leakage in the dashed box in FIG. 13). Hence, as shown in FIG. 28, a critical size dl of the light shielding pattern 221 needs to be greater than the critical size d2 of the spacer 242, i.e., the orthogonal projection of the spacer onto the base substrate is arranged within the orthogonal projection of the light shielding pattern onto the base substrate. In some embodiments of the present disclosure, a boundary of the orthogonal projection of the spacer onto the base substrate is spaced apart from a boundary of the orthogonal projection of the light shielding pattern onto the base substrate by a distance of 0 μm to 0.8 μm. In this way, it is able for the light shielding pattern 221 to shield the light leakage around the spacer 242 in a better manner.

In some embodiments of the present disclosure, the orthogonal projection of the spacer 242 onto the base substrate is arranged within an orthogonal projection of the auxiliary pattern 231 onto the base substrate, and the boundary of the orthogonal projection of the spacer 242 onto the base substrate is spaced apart from a boundary of the orthogonal projection of the auxiliary pattern 231 onto the base substrate by a distance of 0 μm to 0.8 μm, e.g., 0 μm to 0.4 μm, so as to ensure the adhesion between the spacer 242 and the auxiliary pattern 231.

In the embodiments of the present disclosure, the light shielding pattern 221 is made of one or more selected from the group consisting of titanium, molybdenum, aluminum, silver and copper, i.e., one or more of elemental metals, alloys, or metal oxides. For example, the light shielding pattern 221 is made of Mo, so as to achieve a better light shielding effect at a smaller thickness. In order to reduce the overall thickness of the display substrate, a thickness of the light shielding pattern 221 is not greater than 500 angstroms. Further, in the embodiments of the present disclosure, when the light shielding pattern 221 is formed through dry etching, Mo is relatively easy to be etched.

In some embodiments of the present disclosure, a boundary of an orthogonal projection of a first surface of the spacer 242 at a side away from the base substrate onto the base substrate is spaced apart from a boundary of an orthogonal projection of a second surface of the spacer 242 at a side close to the base substrate onto the base substrate by a distance of 0 μm to 0.4 μm, and a maximum width of the second surface is less than or equal to 2 μm. In this way, the orthogonal projection of the first surface onto the base substrate coincides with, or substantially coincides with, the orthogonal projection of the second surface onto the base substrate, so as to reduce a size of an end of the 242 close to the base substrate as well as a size of the light shielding pattern 242, thereby to increase the aperture ratio of the display substrate.

In the embodiments of the present disclosure, the order of the steps is not limited to the serial numbers thereof. For a person skilled in the art, any change in the order of the steps shall also fall within the scope of the present disclosure if without any creative effort.

It should be appreciated that, the above embodiments have been described in a progressive manner, and the same or similar contents in the embodiments have not been repeated, i.e., each embodiment has merely focused on the difference from the others. Especially, the method embodiments are substantially similar to the product embodiments, and thus have been described in a simple manner.

Unless otherwise defined, any technical or scientific term used herein shall have the common meaning understood by a person of ordinary skills. Such words as “first” and “second” used in the specification and claims are merely used to differentiate different components rather than to represent any order, number or importance. Similarly, such words as “one” or “one of” are merely used to represent the existence of at least one member, rather than to limit the number thereof. Such words as “include” or “including” intends to indicate that an element or object before the word contains an element or object or equivalents thereof listed after the word, without excluding any other element or object. Such words as “connect/connected to” or “couple/coupled to” may include electrical connection, direct or indirect, rather than to be limited to physical or mechanical connection. Such words as “on”, “under”, “left” and “right” are merely used to represent relative position relationship, and when an absolute position of the object is changed, the relative position relationship will be changed too.

It should be appreciated that, in the case that such an element as layer, film, region or substrate is arranged “on” or “under” another element, it may be directly arranged “on” or “under” the other element, or an intermediate element may be arranged therebetween.

In the above description, the features, structures, materials or characteristics may be combined in any embodiment or embodiments in an appropriate manner.

The above embodiments are for illustrative purposes only, but the present disclosure is not limited thereto. Obviously, a person skilled in the art may make further modifications and improvements without departing from the spirit of the present disclosure, and these modifications and improvements shall also fall within the scope of the present disclosure.

1. A display substrate, comprising:
a base substrate;
a plurality of first light shielding members arranged on the base substrate and extending in a first direction;
a plurality of light filtering units and a plurality of second light shielding members arranged at a side of the first light shielding member away from the base substrate, the plurality of light filtering units being arranged at intervals, the second light shielding member being filled in a gap between adjacent light filtering units, the second light shielding member extending in a second direction, and the first direction intersecting the second direction;
a planarization layer arranged at a side of the plurality of light filtering units and the plurality of second light shielding members away from the base substrate; and
a spacer arranged at a side of the planarization layer away from the base substrate.

2. The display substrate according to claim 1, wherein surfaces of the plurality of light filtering units and the plurality of second light shielding members at a side away from the base substrate have roughness of less than or equal to 0.5 μm.

3. The display substrate according to claim 1, wherein a height difference between the light filtering unit and the adjacent second light shielding member in a direction perpendicular to the base substrate and away from the base substrate is less than 0.5 μm.

4. The display substrate according to claim 1, wherein a thickness of the planarization layer is less than 1 μm.

5. The display substrate according to claim 1, wherein the first light shielding member is made of an inorganic material.

6. The display substrate according to claim 5, wherein the first light shielding member is made of one or more materials selected from the group consisting of titanium, molybdenum, aluminum, silver and copper.

7. The display substrate according to claim 1, further comprising a light shielding pattern arranged between the spacer and the planarization layer, wherein an orthogonal projection of the spacer onto the base substrate is arranged within an orthogonal projection of the light shielding pattern onto the base substrate, and a boundary of the orthogonal projection of the spacer onto the base substrate is spaced apart from a boundary of the orthogonal projection of the light shielding pattern onto the base substrate by a distance of 0 μm to 0.8 μm.

8. The display substrate according to claim 7, wherein an auxiliary pattern is further arranged between the light shielding pattern and the spacer, the orthogonal projection of the spacer onto the base substrate is arranged within an orthogonal projection of the auxiliary pattern onto the base substrate, and the boundary of the orthogonal projection of the spacer onto the base substrate is spaced apart from a boundary of the orthogonal projection of the auxiliary pattern onto the base substrate by a distance of 0 μm to 0.8 μm.

9. The display substrate according to claim 8, wherein the boundary of the orthogonal projection of the light shielding pattern onto the base substrate is spaced apart from the boundary of the orthogonal projection of the auxiliary pattern onto the base substrate by a distance of 0 μm to 0.4 μm.

10. The display substrate according to claim 7, wherein the light shielding pattern is made of one or more materials selected from the group consisting of titanium, molybdenum, aluminum, silver and copper.

11. The display substrate according to claim 1, wherein a boundary of an orthogonal projection of a first surface of the spacer at a side away from the base substrate onto the base substrate is spaced apart from a boundary of an orthogonal projection of a second surface of the spacer at a side close to the base substrate onto the base substrate by a distance of 0 μm to 0.4 μm, and a maximum width of the second surface is less than or equal to 2 μm.

12. The display substrate according to claim 11, wherein a ratio of a height to the maximum width of the spacer is greater than 1.5.

13. A method for manufacturing a display substrate, comprising:
providing a base substrate;
forming a plurality of first light shielding members on the base substrate, the first light shielding member extending in a first direction;
forming a plurality of light filtering units at a side of the first light shielding member away from the base substrate, the plurality of light filtering units being arranged at intervals;
forming a plurality of second light shielding members, each second light shielding member being filled in a gap between adjacent light filtering units, the second light shielding member extending in a second direction, and the first direction intersecting the second direction;
forming a planarization layer at a side of the plurality of light filtering units and the plurality of second light shielding members away from the base substrate; and
forming a spacer at a side of the planarization layer away from the base substrate.

14. The method according to claim 13, wherein an opposing substrate of the display substrate comprises a gate line and a data line, the first direction is an extension direction of the data line, and the second direction is an extension direction of the gate line.

15. The method according to claim 13, wherein the forming the plurality of first light shielding members comprises: forming a metal thin film on the base substrate; and patterning the metal thin film to form the plurality of first light shielding members.

16. The method according to claim 13, further comprising:
forming a light shielding pattern between the spacer and the planarization layer, an orthogonal projection of the spacer onto the base substrate being arranged within an orthogonal projection of the light shielding pattern onto the base substrate; and
forming an auxiliary pattern between the light shielding pattern and the spacer.

17. The method according to claim 16, wherein the forming the spacer, the light shielding pattern and the auxiliary pattern specifically comprises:
forming a light-shielding metal layer on the planarization layer;
forming an inorganic insulation layer on the light-shielding metal layer;
forming a spacer material layer on the inorganic insulation layer;
forming a hard mask layer on the spacer material layer;
forming a photoresist layer on the hard mask layer;
exposing and developing the photoresist layer to form a photoresist pattern;
etching the hard mask layer with the photoresist pattern as a mask to form a first hard mask pattern;
etching the light-shielding metal layer, the inorganic insulation layer and the spacer material layer with the first hard mask pattern as a mask to form the light shielding pattern, the auxiliary pattern, and a spacer transition pattern respectively;
etching the photoresist pattern and the first hard mask pattern to reduce a size of the first hard mask pattern, so as to form a second hard mask pattern;
etching the spacer transition pattern with the second hard mask pattern as a mask to form the spacer; and
removing the second hard mask pattern and the remaining photoresist.

18. The display substrate according to claim 2, further comprising a light shielding pattern arranged between the spacer and the planarization layer, wherein an orthogonal projection of the spacer onto the base substrate is arranged within an orthogonal projection of the light shielding pattern onto the base substrate, and a boundary of the orthogonal projection of the spacer onto the base substrate is spaced apart from a boundary of the orthogonal projection of the light shielding pattern onto the base substrate by a distance of 0 μm to 0.8 μm.

19. The display substrate according to claim 3, further comprising a light shielding pattern arranged between the spacer and the planarization layer, wherein an orthogonal projection of the spacer onto the base substrate is arranged within an orthogonal projection of the light shielding pattern onto the base substrate, and a boundary of the orthogonal projection of the spacer onto the base substrate is spaced apart from a boundary of the orthogonal projection of the light shielding pattern onto the base substrate by a distance of 0 μm to 0.8 μm.

20. The display substrate according to claim 4, further comprising a light shielding pattern arranged between the spacer and the planarization layer, wherein an orthogonal projection of the spacer onto the base substrate is arranged within an orthogonal projection of the light shielding pattern onto the base substrate, and a boundary of the orthogonal projection of the spacer onto the base substrate is spaced apart from a boundary of the orthogonal projection of the light shielding pattern onto the base substrate by a distance of 0 μm to 0.8 μm.
